(19) United States
(12) Patent Application Publication
(10) Pub. No.: US 2001/0023557 A1
(43) Pub. Date: Sep. 27, 2001

(54) Door frame device

(76) Inventor: Kieran Graham, Ballymena (IE)

Correspondence Address: VOLPE AND KOENIG, P.C., SUITE 400, ONE PENN CENTER, 1617 JOHN F. KENNEDY BOULEVARD, PHILADELPHIA, PA, 19103, US

(21) Appl. No.: 09/759,591

(22) Filed: Jan. 12, 2001

(30) Foreign Application Priority Data
Jan. 14, 2000 (GB) GB0000696.5

(51) Int. Cl. E06B 1/04

(52) U.S. Cl. 49/504; 49/381; 52/204.1; 52/656.1

(57) ABSTRACT

The present invention provides a door frame device which comprises a first substantially F section bracket from which a door may be hung, for engagement with one lateral face of a wall, a second substantially L section bracket oppositely disposed to and slidably engagable with the first bracket, for engagement with an opposite lateral face of the wall, the device therefore being capable of accommodating walls of varying thickness in order to permit quick and simple fitting of a door frame.

The present invention concerns a door frame device.

It is well acknowledged in the art of framing and hanging doors that there are several factors which impede the frame, door and fittings from being fully finished prior to fitting to the wall. These include the fact that the thicknesses of the walls to which the frames are to be fitted may vary considerably, thereby requiring on-site adjustment of the door frames to suit the particular wall thickness. In addition to this, the exposed face of the stud walls are more often than not off-square (off-vertical or substantially non-vertical), requiring the insertion of wedges or the adjustment of the frame in order to ensure that the door is hung square. It is therefore quite time consuming to fit a door frame on site, as each individual component of the frame must be adjusted to suit the particular conditions of the respective wall to which the frame is to be fitted.

The present invention overcomes these problems by providing a door frame device from which a door may be hung, the device comprising a first bracket and a second bracket; the first bracket comprising a first wall engaging section, and first and second inwardly extending members, defining, therebetween, a longitudinally extending channel; and the second bracket comprising a second wall engaging section, and a tongue shaped and dimensioned for sliding engagement in the channel of the first bracket so that, in use, the device is capable of accommodating walls of varying thickness.

Preferably the first wall engaging section and the first and second inwardly extending members of the first bracket define a substantially F shaped cross section and the second wall engaging section and the tongue of the second bracket define a substantially L shaped cross section.

Preferably, the device further comprises a spacer element for engagement between the device and an end face of the wall so that, in use, the device is substantially vertically aligned, thereby ensuring the device is capable of accommodating irregular or off-vertical wall end faces between the device and the wall.

The term off-vertical is used herein to define an orientation of an end face of a wall which does not lie exactly in a vertical plane.

Preferably the spacer element comprises a female portion, and a male portion engaged within and adjustable relative to the female portion.

Preferably the male portion of the spacer element is slidably engaged within the female portion, the male portion incorporating a rack and the female portion incorporating a communicating pinion which is operable to effect adjustment of the male portion such as to provide adjustment of the door frame device relative to the wall.

Preferably in a spatial arrangement the spacer element is adapted to permit fixing of the device to the wall.

Preferably the device comprises a substantially Z section hinge mounted between the door and the device, thereby providing a draft excluding and fire retarding flange between the door and the device.

Preferably the substantially Z section hinge comprises a substantially Z sectioned backing plate and a substantially Z section hinge plate hingedly connected together, the backing plate and the hinge plate seated flush with one another when the hinge is in the closed position, thereby providing, in use, the flange between the door and the door frame device.

According to a second aspect of the present invention there is provided a substantially Z section hinge for mounting between either a standard door frame or a door frame device according to a first aspect of the invention, the substantially Z section hinge comprising a substantially Z section backing plate and the substantially Z section hinge plate hingedly connected together, the backing plate and the hinge plate seated flush with one another when the hinge is in the closed position, thereby providing, in use, the flange between the door and the door frame or door frame device.

According to a third aspect of the present invention there is provided a spacer element when used with either a standard door frame or a door frame device according to a first aspect of the invention, the spacer element comprising a male portion which is slidably engaged within a female portion; the male portion incorporating a rack and the female portion incorporating a communicating pinion which is operable to effect adjustment of the male portion such as to provide adjustment of the door frame or door frame device relative to a stud wall.

The present invention will now be described with reference to the accompanying drawings in which;

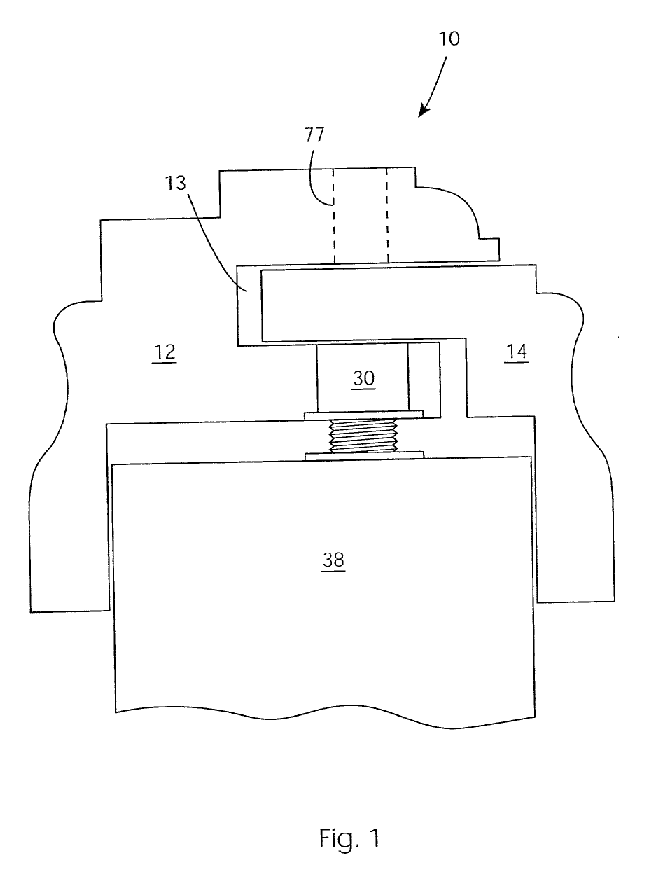

FIG. 1 illustrates a sectioned plan of a door frame device according to a first aspect of the present invention, wherein both first and second brackets of the door frame device are illustrated as single components for the purposes of clarity;

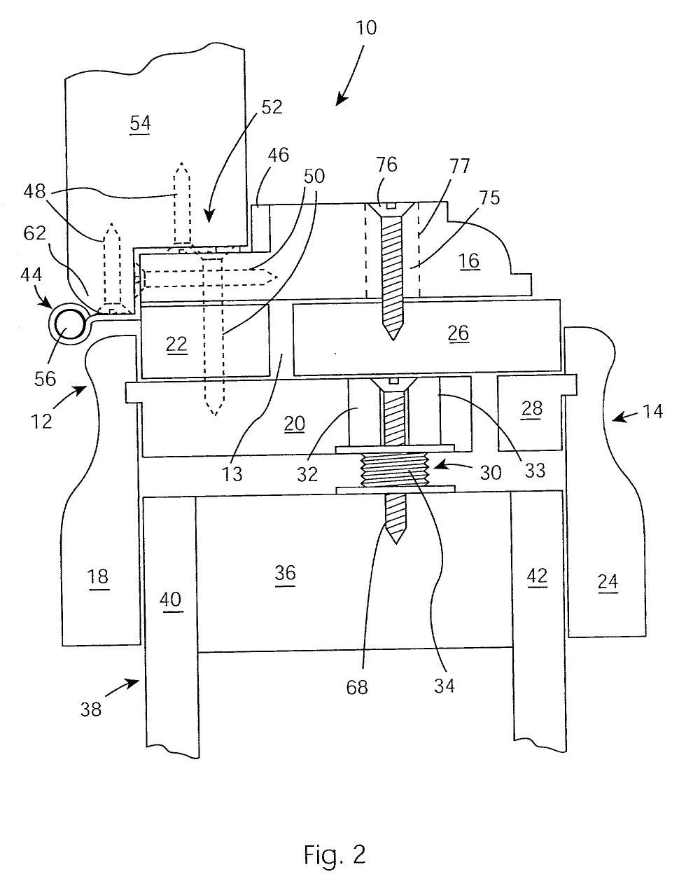

FIG. 2 illustrates a sectioned plan of the door frame device illustrating the actual construction of the door frame device of FIG. 1;

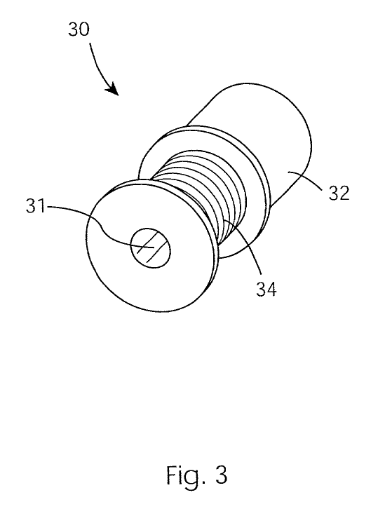

FIG. 3 illustrates a perspective view of a first embodiment of a spacer element according to a third aspect of the present invention;

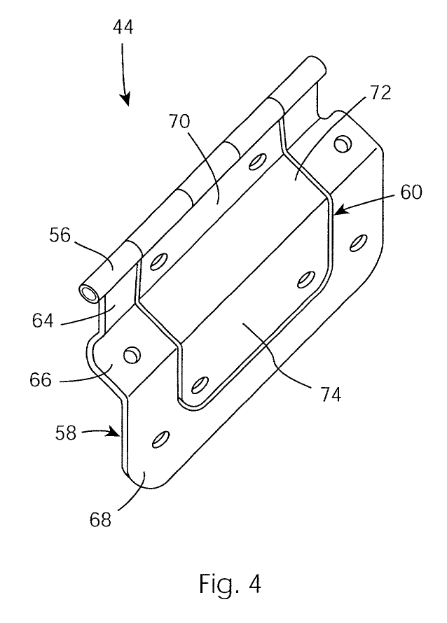

FIG. 4 illustrates a perspective view of a hinge according to a second aspect of the present invention;

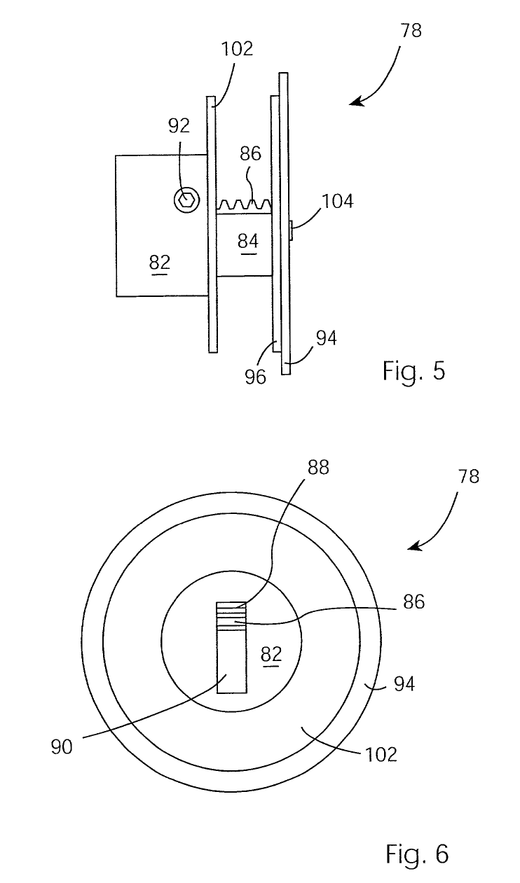

FIG. 5 illustrates a side elevation of an alternative embodiment of the spacer element of FIG. 3;

FIG. 6 illustrates a front elevation of the spacer element of FIG. 5; and

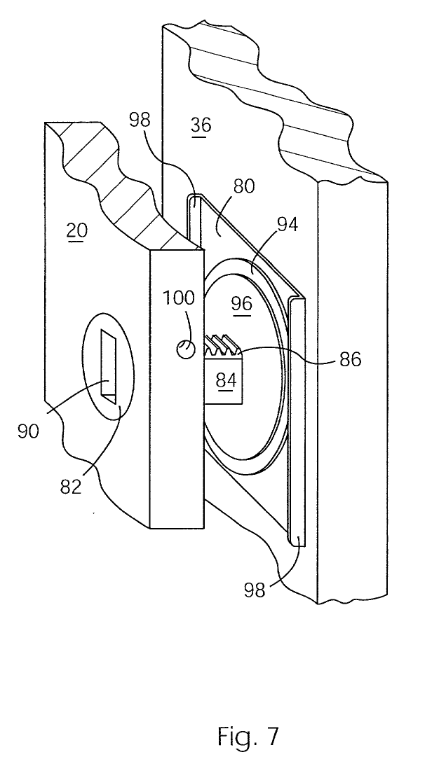

FIG. 7 illustrates a perspective view of the spacer element of FIG. 5, located in position within the door frame and abutting against a stud wall.

Referring now to the accompanying drawings there is illustrated a door frame device, generally indicated as 10, for fitting to a wall 38. The device 10 consists of a first bracket 12 and a second bracket 14 which are slidably engageable relative to one another, and which abut against a first face 40 and a second face 42 respectively, of the wall 38. Located between the first face 40 and the second face 42 is a stud wall 36 forming the end of the wall 38. Referring in particular to FIG. 1, both the first bracket 12 and the second bracket 14 are illustrated, for the purposes of clarity, as single unified components which are slidably engagable with one another such that a variety of wall thicknesses (not shown) may be accommodated therebetween.

Referring to FIG. 2, the first bracket 12 consists of a first wall engaging section 18 which is seated, in use, flush with the first face 40; a first inwardly extending member 20 projecting normally from the first wall engaging section 18; a spacing block 22 connected to both the first inwardly extending member 20 and the first wall engaging section 18, preferably by gluing, and a second inwardly extending member 16 connected to the spacing block 22 and positioned normally to the first wall engaging section 18 again preferably fixed with glue. The first bracket 12 is therefore substantially F-shaped in form as can be more clearly seen from FIG. 1. The first inwardly extending member 20 has a cylindrical aperture 33 formed therein, into which is fixed a spacer element 30.

Referring in particular to FIG. 3, there is illustrated the spacer element 30 which includes an outer sleeve 32 (as seen in section in FIG. 2) which is located, in use, in the aperture 33 of the first inwardly extending member 20, and into which is threaded an inner sleeve 34. The inner sleeve 34 is seated between the first inwardly extending member 20 and the stud wall 36 and can be adjusted axially to vary the position of the first member 20 and, therefore, the first bracket 12 in relation to the stud wall 36, in order that the device 10 is correctly disposed for hanging a door 54 i.e., is substantially vertically disposed, irrespective of whether the stud wall 36 is off-vertical or not. The inner sleeve 34 is adjustable by means of a hexagonal sectioned aperture 31 formed axially through the centre thereof, for receiving an allen key (not shown). The inner sleeve 34 can therefore be adjusted axially using the allen key (not shown). To this end, the first bracket 12 is provided with an aperture 77 which passes directly through the second inwardly extending member 16, and is in direct alignment with the aperture 33 in which, in use, the spacer element 30 is located as illustrated in FIGS. 1 and 2.

Referring to FIGS. 1 and 2, in order to effect adjustment of the spacer element 30, the device 10 is engaged against the wall 38, and the second bracket 14 slid out of engagement with the first bracket 12. It will therefore be appreciated that an allen key (not shown) may be passed through the aperture 77 and engaged within the hexagonal sectioned aperture 31 of the spacer element 30, in order to effect axial adjustment thereof. Once the spacer element 30 has been adjusted, the second bracket 14 is slid back into engagement with the first bracket 12.

It will be appreciated that there are usually a plurality of such spacer elements 30 disposed along the length of the first inwardly extending member 20, thereby facilitating the precision substantially vertical alignment of the device 10 to the wall 38, regardless of the contour of the stud wall 36.

In an alternative arrangement (not shown), the spacer element 30 may be of elongate form and pass across a channel 13 and be seated within the second inwardly extending member 16 in addition to the first inwardly extending member 20. In such an arrangement, the aperture 77 would necessarily be of a diameter similar to that of the aperture 33 in the first inwardly extending member 20, in order to accommodate the outer sleeve 32 of the spacer element 30, However, as the spacer element 30 would pass across the channel 13, it would be necessary to provide the tongue 26 with a slot having a width sufficient to accommodate the spacer element 30.

Referring now to FIGS. 4 to 6, there is illustrated an alternative embodiment of the spacer element, indicated as 78. The spacer element 78 consists of a male portion 84 mounted on a base plate 96, which in turn has a backing plate 94 mounted eccentrically thereto by means of an off-centre located pin 104 (FIG. 5). Fixed to the male portion 84 is a rack 86. The spacer element 78 further includes a female portion 82 which is cylindrical in form and includes a flange 102 at one end thereof. The female portion 82 contains a slot 90 extending therethrough, the slot 90 being shaped and dimensioned to receive the male portion 84. Located transversely across an upper portion of the slot 90 is a pinion 88 which engages, in use, the rack 86 such as to effect relative movement between the male portion 84 and the female portion 82. The pinion 88 is mounted on a spring loaded spindle 92 which is accessible through the female portion 82, as illustrated in FIG. 5, and is operable by means of an allen key (not shown).

The spindle 92 is normally locked in position, in order to prevent inadvertent movement of the pinion 88. However, if the spindle 92 is pressed inwardly, using the allen key (not shown), the lock is released and the spindle 92 is therefore freely rotatable. The pinion 88 may therefore be operated to move the male portion 84 relative to the female portion 82.

Referring now to FIG. 7, the spacer element 78 is located, in use, having the female portion 82 contained within the first inwardly extending member 20 against which the flange 102 abuts (not shown in FIG. 7). The first inwardly extending member 20 is provided with a bore 100 which is located, in use, in register with the spindle 92 in order to facilitate access to the spindle 92 such as to allow adjustment of the pinion 88. A guide rail 80 is mounted to the stud wall 36, the guide rail 80 having a pair of oppositely disposed lips 98 spaced apart a distance substantially equal to the diameter of the backing plate 94. In use, the backing plate 94 is seated between the pair of lips 98 and acts essentially as an cam which is capable of eccentric rotation about the pin 104, with the guide rail 80, and in particular the pair of lips 98, acting as a cam follower. As the backing plate 94 is eccentrically mounted to the base plate 96, the lateral position of the first inwardly extending member 20 may be adjusted relative to the stud wall 36 to further increase the adjustability of the door frame device 10, by manual rotation of the backing plate 94 relative to the base plates 96.

In the present embodiment, a plurality of the spacer element(s) 30/78 are disposed along the length of the first inwardly extending member 20. However, the present invention also envisages that a single spacer element 30/78 may be used to advantage.

The device 10 further includes a second bracket 14 which, in use, abuts against the second face 42 of the wall 38. The second bracket 14 consists of a second wall engaging section 24, a tongue 26 normally disposed to the second wall engaging section 24, and a support 28 postitioned between the tongue 26 and the second wall engaging section 24 to provide additional strength to the second bracket 14. The second bracket 14 is substantially L-shaped in form, the tongue 26 being slidably engaged in the channel 13 formed between the first inwardly extending member 20 and the second inwardly extending member 16 of the first bracket 12. It will therefore be appreciated that the second bracket 14 may be slid towards or away from the first bracket 12, thereby adjusting the width between the first wall engaging section 18 and the second wall engaging section 24, between which is located the wall 38. In this way, walls of varying thickness can be accommodated.

In operation, therefore, the first bracket 12 is located with the first wall engaging section 18 abutting against the first face 40 of the wall 38, and the, or each, spacer element 30 abutting against the stud wall 36. The, or each, spacer element 30 located along the length of the first inwardly extending member 20 is/are then adjusted until the first bracket 12 is square and plumb in orientation. The first bracket 12 is then fixed in this position by means of a screw 68 (FIG. 2) which passes through the centre of the spacer element 30 and into the stud wall 36. The screw 68 may be seated within the spacer element 30 by passing the screw 68 through the aperture 77 and the channel 13. Once the screw 68 is engaged within the spacer element 30 and the stud wall 36, the second bracket 14 is then slid into engagement with the first bracket 12 until the second wall engaging section 24 abuts against the second face 42 of the wall 38. At this stage a threadless tubular insert 75 is pressed into engagement within the aperture 77, and is preferably glued into place. A screw 76 is then threaded downwardly through the tubular insert 75 and engaged within the tongue 26 of the second bracket 14. It will therefore be appreciated that the screw 76 retains the first bracket 12 and the second bracket 14 relative to one another, and that a plurality of said screws 76 are disposed along the length of the device 10.

Mounted between the door 54 and the second inwardly extending member 16 adjacent the first wall engaging section 18 is a hinge 44, as illustrated in FIG. 4. Equally, of course, a conventional hinge (not shown) may be employed. The hinge 44 is of open substantially Z-section form and comprises a standard spine 56, to which is connected a substantially Z shaped backing plate 58 and a hinge plate 60 which is seated flush with the backing plate 58 when the hinge 44 is in the closed position. The backing plate 58 comprises a first spine-plate 64 projecting from the spine 56, a first cross-plate 66 connected to and projecting normally from the first spine-plate 64, and a first end-plate 68 projecting normally from the first cross-plate 66. The hinge plate 60 also comprises a second spine-plate 70, a second cross-plate 72 and a second end-plate 74 in the same orientation as the open substantially Z-section backing plate 58.

The hinge 44 is mounted to the second inwardly extending member 16 by means of four fitting screws 50 (only two visible in FIG. 2) and is similarly connected to the door 54 by means of four door screws 48 (only two visible in FIG. 2). Due to the substantially Z-section configuration of the hinge 44, a notch 52 must be removed from the length of the second inwardly extending member 16 in order to accommodate the hinge 44. The configuration of the hinge 44 in association with the notch 52 results in the formation of a flange 62 which provides draft exclusion and fire retardation between the door 54 and the first bracket 12. A further draft excluder 46 may be fitted between the second inwardly extending member 16 and the door 54. It would also be possible, were the second inwardly extending member 16 reduced in length, to fit the hinge 44 to the tongue 26 of the second bracket 14.

It will be appreciated that both the first bracket 12 and second bracket 14 may be fully finished prior to being fitted to the wall 38. This, coupled with the ability to slidably engage the second bracket 14 with the first bracket 12, and the adjustability provided by the spacer element 30, substantially reduces the time taken to install the device 10 relative to the time requited to fit a standard door frame (not shown). It will also be readily understood that the device 10 could be used, without the hinge 44, to form the remaining sides of a door frame (not shown), including the horizontally disposed upper portion of the frame (not shown).

1. A door frame device from which a door may be hung, the device comprising a first bracket and a second bracket; the first bracket comprising a first wall engaging section, and first and second inwardly extending members, defining, therebetween, a longitudinally extending channel; and the second bracket comprising a second wall engaging section, and a tongue shaped and dimensioned for sliding engagement in the channel of the first bracket so that, in use, the device is capable of accommodating walls of varying thickness.

2. A device according to claim 1 wherein the first wall engaging section, and the first and second inwardly extending members of the first bracket define a substantially F shaped cross section and the second wall engaging section and the tongue of the second bracket define a substantially L shaped cross section.

3. A door frame device according to claim 1 wherein the device further comprises a spacer element for engagement between the device and an end face of the wall so that, in use, the device is, substantially vertically aligned, thereby ensuring the device is capable of accommodating irregular or off-vertical wall end faces between the device and the wall.

4. A door frame device according to claim 3 wherein the spacer element comprises a female portion and a male portion engaged within and adjustable relative to the female portion.

5. A door frame device according to claim 4 wherein the male portion of the spacer element is slidably engaged within the female portion, the male portion incorporating a rack and the female portion incorporating a communicating pinion which is operable to effect adjustment of the male portion such as to provide adjustment of the door frame device relative to the wall.

6. A door frame device according to any one of claims 3 to 5 wherein in a partial arrangement the spacer element is adapted to permit fixing of the device to the wall.

7. A door frame device according to claim 1 wherein the device comprises a substantially Z section hinge mounted between the door and the device, thereby providing a draft excluding and fire retarding flange between the door and the device.

8. A door frame device according to claim 7 wherein the substantially Z section hinge comprises a substantially Z sectioned backing plate and a substantially Z section hinge plate hingedly connected together, the backing plate and the hinge plate seated flush with one another when the hinge is in the closed position, thereby providing, in use, the flange between the door and the door frame device.

9. A substantially Z section hinge for mounting between either a standard door frame or a door frame device according to claim 1, the substantially Z section hinge comprising a substantially Z section backing plate and the substantially Z section hinge plate hingedly connected together, the backing plate and the hinge plate seated flush with one another when the hinge is in the closed position, thereby providing, in use, a flange between the door and the door frame or door frame device.

10. A spacer element when used with either a standard door frame or a door frame device according to claim 1, the spacer element comprising a male portion which is slidably engaged within a female portion; the male portion incorporating a rack and the female portion incorporating a communicating pinion which is operable to effect adjustment of the male portion such as to provide adjustment of the door frame or door frame device relative to a stud wall.
